(19) United States
(12) Patent Application Publication
(10) Pub. No.: US 2005/0093770 A1
(43) Pub. Date: May 5, 2005

(54) System and method for a data format for command encapsulation

(76) Inventors: Jeremy S. de Bonet, North Andover, MA (US); Hanqing Liao, Danville, CA (US); James B. Roseborough, Berkeley, CA (US); Kent V. Klinner III, Lafayette, CA (US)

Correspondence Address: SPRINKLE IP LAW GROUP, 1301 W. 25TH STREET, SUITE 408, AUSTIN, TX, 78705, US

(21) Appl. No.: 10/975,637

(22) Filed: Oct. 28, 2004

Related U.S. Application Data
(60) Provisional application No. 60/516,444, filed on Oct. 31, 2003.

(51) Int. Cl. G09G 1/06

(52) U.S. Cl. 345/10

(57) ABSTRACT

Systems and methods for data formats which facilitate the encapsulation, transmission, reception, decomposition and processing of heterogeneous sets of data are disclosed. Data may be encoded in one of these data formats, and sent to a recipient, which decodes the data format and renders the data. These data formats may consist of the concatenation of a set of commands, each of these commands in turn composed of a tag, length and a payload. Furthermore, these data formats may provide a compact way to deliver information which allows the rendering of video, images, caption audio as well as user interaction functionality, while simultaneously reducing the computational complexity required of the recipient to decode the data format and render the varying types of data.

### RELATED APPLICATIONS

This application claims a benefit of priority under 35 U.S.C. § 119 to the filing date of, U.S. Provisional Patent Application Ser. No. 60/516,444 by inventors Jeremy S. de Bonet and Hanqing Liao, entitled “Command Encapsulation Format System and Method” filed on Oct. 31, 2003, the entire contents of which are hereby expressly incorporated by reference for all purposes.

This application is related to U.S. patent application Ser. Nos. 10/342,113 by inventors Jeremy S. de Bonet and Todd Stiers, entitled “Network Proxy Platform that Simultaneously Supports Data Transformation, Storage, and Manipulation for Multiple Protocols” filed on Jan. 14, 2003; Ser. No. 10/347,138 by inventor Jeremy S. de Bonet, entitled “Method for Isolating and Protecting Software Components to Increase Reliability and Prevent Inadvertent Corruption” filed on Jan. 17, 2003; Ser. No. 10/345,101 by inventors Jeremy S. de Bonet, Todd Stiers and Jeffrey R. Annison entitled “Method and System of Accessing Shared Resources Using Configurable Management Information” filed on Jan. 15, 2003; Ser. No. 10/345,067 by inventors Jeremy S. de Bonet entitled “Method and System of Protecting Shared Resources Across Multiple Threads” filed on Jan. 15, 2003; Ser. No. 10/664,246 by inventors Jeremy S. de Bonet, Todd Stiers, Phillip Alvelda and Jeffrey R. Annison entitled “System and Method for the Packaging and Distribution of Data” filed on Sep. 17, 2003; ______ by inventor Jeremy S. de Bonet, entitled “System and Method for a Synchronized Shared Buffer Architecture for ultimedia Players” filed on Oct. 28, 2004 (ATTY. DOCKET NUMBER IDET1150-1) and ______ by inventor Jeremy S. de Bonet, entitled “System and Method for a Symmetric Architecture for Multimedia Players” filed on Oct. 28, 2004 (ATTY. DOCKET NUMBER IDET1140-1); the entire contents of which are hereby expressly incorporated by reference for all purposes.

### TECHNICAL FIELD OF THE INVENTION

The invention relates in general to methods and systems for data formats, and more particularly, to methods and systems for encapsulating heterogeneous data in a manner which facilitates manipulation of the data.

### BACKGROUND OF THE INVENTION

The use of computer networks to store data and provide information to users is increasingly common. A microcosm of this phenomenon can be seen in the prevalence of the internet. The internet is used to distribute a wide variety of content to users, including video, audio, text, images etc. Each of these types of content may, in turn, be distributed in a wide variety of formats. These various types of content may be themselves packaged in a variety of payload formats and delivered via a whole host of application and transmission protocols.

In most cases, a user at a client computer wishes to access a certain piece of data and makes a request to a server computer for that piece of data. The server computer encapsulates the requested data in a set of packages for delivery to the client computer. The encapsulation methodology used by the server depends on the variables mentioned above, the type of content, the format of that content, the format of the payload, the application and transmission protocols being used to send the data etc. Upon receiving a package, the client computer must peel back the layers of the raw data received to ascertain the content and payload format used to package the data so the data may be processed and rendered correctly.

In most cases, the tasks of deciphering, decoding, and rendering the received data falls to a multimedia player residing on the client computer. Because these tasks are often times computationally intensive, and the data may come in variety of formats, multimedia players tend to be large and monolithic, requiring large amounts of space to store, memory to operate and processor time to execute.

When performing these tasks on a workstation or desktop environment, these issues are not so problematic. Most workstations or desktop computers have fast enough processors and large enough memories to accommodate the multimedia players with little difficulty. In a mobile environment, however, these issues may become problematic. Cellular telephones, PDAs, mobile computers etc. simply do not have the processing power or space to be able to efficiently evaluate and render raw multimedia data.

The ability of these devices has not however quenched the thirst of their users for data of this type. In fact, the increasing prevalence of these types of mobile devices has only increased the demand for multimedia data in a mobile environment.

Typically, to distribute multimedia data to mobile devices some reduction in the data rate is utilized to make the transfer, decoding and rendering of the multimedia data more efficient. This may be achieved by distributing the requested multimedia in a lower fidelity, or at a lower sampling rate. This is a non optimum solution, a wireless device in one area may have a certain bandwidth while another device may have a much lower bandwidth (e.g. in a tunnel, or area of low reception), and the bandwidth of each device on a network may vary dynamically.

No matter the fidelity or sampling rate of the data, however, the client device is still responsible for the decoding and rendering of the raw data received from the server. Consequently, the decoding and rendering of the received raw data remains a significant bottleneck at the client device.

Thus, a need exists for systems and methods for a data format which reduces the computational power necessary to decode or evaluate the encapsulated data.

### SUMMARY OF THE INVENTION

Systems and methods for data formats which facilitate the encapsulation, transmission, reception, decomposition and processing of heterogeneous sets of data are disclosed. Data may be encoded in one of these data formats, and sent to a recipient, which decodes the data format and renders the data. These data formats may consist of the concatenation of a set of commands, each of these commands in turn composed of a tag, length and a payload. Furthermore, these data formats may provide a compact way to deliver information which allows the rendering of video, images, caption audio as well as user interaction functionality, while simultaneously reducing the computational complexity required of the recipient to decode the data format and render the varying types of data.

In one embodiment, a set of commands is formed, each command comprising a command identifier, a length indicator, and a data payload; these commands are then concatenated.

In another embodiment, the set of commands is formed based on the data.

In yet another embodiment, the commands are concatenated based on the order of execution.

In still another embodiment, the set of commands is operable to render the data.

In other embodiments, the data may be image data, video data, audio data, text data or user interaction data.

In some other embodiment, the data payload is a portion of the data.

In yet other embodiments, the command identifier is followed by the length, and the length is followed by the payload.

In still other embodiments, the command identifier is a byte.

In some embodiments, the command identifier is multiple bytes, a partial byte or a string.

In one embodiment, the length indicator specifies the length of the command.

In one embodiment, the length is 12 digits.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 is a block diagram of an exemplary system for use with embodiments of the present invention.

FIG. 2 is a flow diagram of an embodiment of the present invention.

FIG. 3 is a depiction of an embodiment of converting portions of data, encapsulating these portions in packets and selecting packets to be delivered to a device.

FIG. 4 is a depiction of an embodiment of the reception and processing of incoming packets by a mobile device.

### DESCRIPTION OF PREFERRED EMBODIMENTS

The invention and the various features and advantageous details thereof are explained more fully with reference to the nonlimiting embodiments that are illustrated in the accompanying drawings and detailed in the following description. Descriptions of well known starting materials, processing techniques, components and equipment are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure.

A few terms are defined or clarified to aid in understanding the descriptions that follow: a device may be any sort of apparatus which can receive and display data including mobile phones, PDAs, laptop computers and the like.

A format is a way of arranging, organizing, or representing data, usually using a defined standard such as MPEG or motion JPEG. For purposes of this application, formats will be understood to be distinct if characteristics of the represented data differ in any manner. Additionally the same standard at two different rates will be understood to mean two distinct formats. For example, high framerate motion JPEG would be a distinct format from low framerate motion JPEG. Furthermore, augmenting a defined standard with additional information will be understood to constitute a distinct format. For example, augmenting an MPEG representation of video data with closed captioning information would be a distinct format from video data represented in the MPEG format alone. Compressed video data will also be understood as distinct from its uncompressed equivalent. For example, video data compressed with MPEG will be understood as distinct format from identical uncompressed raw video data. It will be obvious to those of ordinary skill in the art that for purposes of this application, distinct formats may be created in an almost endless variety of ways, such as varying resolution, screen size, sampling rate, and the like.

A packet is intended to mean any set of data, including a set of data operable or configured for transmission.

Though the exemplary embodiment described below utilizes embodiments of the present invention in a media bridge designed to convert broadcast media such as television into a variety of formats for delivery over a wireless communication network, those skilled in the art will appreciate that these same systems and methods may be employed for a myriad number of other uses and applications, such as delivering internet content over a wireline system, or other type of network topology. Additionally, it will be understood that these same systems and methods, or any subset, can be implemented in a variety of software systems, computer programs, hardware, and any combination thereof.

Attention is now directed to systems and methods for data formats which facilitate the encapsulation, transmission, reception, decomposition and processing of heterogeneous sets of data. Data may be encoded in one of these data formats, and sent to a recipient, which decodes the data format and renders the data. These data formats may consist of the concatenation of a set of commands, each of these commands in turn composed of a tag, length and a payload. Furthermore, these data formats may provide a compact way to deliver information which allows the rendering of video, images, caption audio as well as user interaction functionality, while simultaneously reducing the computational complexity required of the recipient to decode the data format and render the varying types of data. These data formats may be ideally suited for distributing data in a client-server architecture where the encoding server is powerful relative to the many clients.

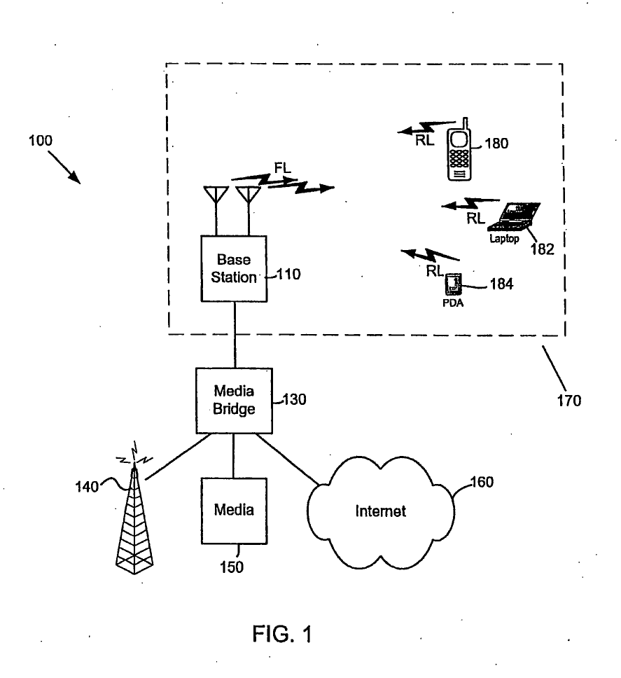

Turning now to FIG. 1, a diagram illustrating the structure of an exemplary communications system for utilization with embodiments of the present invention is shown. As depicted in this figure, this system 100 comprises a media bridge 130 for interfacing between different types of content systems 140, 150, 160 and one or more wireless (or potentially wireline) communication networks 170. Content systems 140, 150, 160 may be broadcast media such as television or radio, other audio or video data, such as a video feed from a DVD player, or the Internet.

Wireless communication network 170 is in turn composed of base station 110 that is configured to communicate with a plurality of mobile devices (devices) 180, 182, 184. Mobile devices 180, 182, 184 may, for example, be cellular telephones, laptop computers, personal information managers (PIMs or PDA), or the like that are configured for wireless communication. These devices 180, 182, 184 may be running software designed for use with embodiments of the present invention. It should be noted that these devices 180, 182, 184 need not actually be “mobile,” but may simply communicate with base station 110 via a wireline or wireless link. Base station 110 transmits data to mobile devices 180, 182, 184 via corresponding forward link (FL) channels, while mobile devices 180, 182, 184 transmit data to base station 110 via corresponding reverse link (RL) channels.

Users of mobile devices 180, 182, 184 may wish to have content from content sources 140, 150, 160 delivered to them. This may be problematic, however, as delivery of much of this content typically requires large amounts of data to be delivered over a high-reliability high-bandwidth connection. Additionally, even if wireless network 170 is such a high-bandwidth network, mobile devices 180, 182, 184 may experience temporary periods of low-bandwidth connection to base station 110, or may be incapable of handling the complexity of such content. Media bridge 130 alleviates these problems by delivering tailored content from content source 140, 150, 160 to each individual mobile device 180, 182, 184.

Media bridge 130 may employ embodiments of the present invention to encapsulate content from content sources 140, 150, 160 for delivery to mobile devices 180, 182, 184 in a data format which is compact, and simplifies the tasks of decoding and rendering the data format performed by mobile devices 180, 182, 184. Streaming content from a content source 140, 150, 160 is fed into media bridge 130, at which point media bridge 130 may capture and digitize the incoming content if the data is not already in a digital format. This digitized data may be divided up into serialized portions and converted to a wide variety of formats. This data can then be encapsulated in packets with a certain data format and a particular series of packets may be sent to base station 110 for delivery to mobile device 180, 182, 184 depending on criteria associated with that particular device 180, 182, 184. It should be noted that the mobile devices 180, 182, 184 and system components in this figure are exemplary and other systems may comprise other types and other combinations of devices.

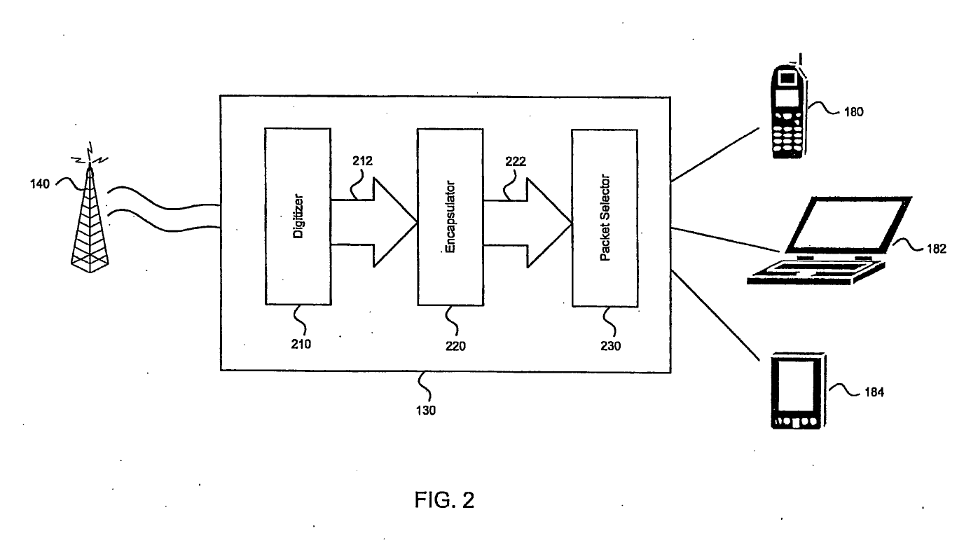

Embodiments of the steps involved in the distribution of data by media bridge 130 are depicted in more detail in FIG. 2. Content coming from media source 140 which is to be delivered to a device 180 may be in an analog format. This analog content, such as a television signal, radio broadcasts or video game data, may be captured using automatic or manual capture methods, and converted to a digital signal (STEP 210). One of ordinary skill in the art will understand the many and varied ways to accomplish this capture and analog to digital conversion (STEP 210). In one embodiment, raw TV signal 140 may be connected to a TV tuner capture card, which in turn captures incoming analog TV signal 140. This analog signal 140 may be converted to a digital signal via the use of a standard analog to digital converter of the type that are well known in the art.

The resulting digital data 212 may be converted to a variety of formats and encapsulated in packets (STEP 220) in order to facilitate delivery of data 212 to device 180. Packets of this data 222 may then be selected for delivery (STEP 230) to device 180 based upon a set of criteria.

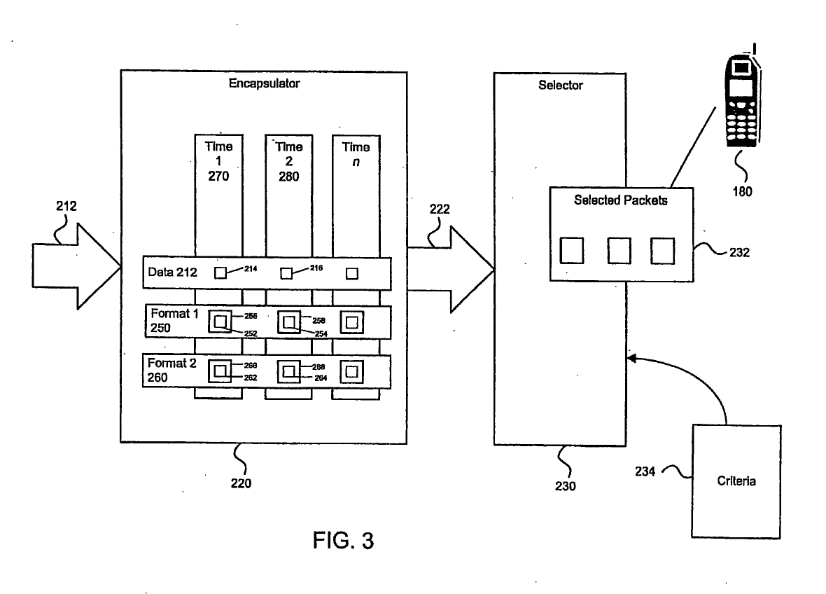

Moving now to FIG. 3, embodiments of the process for encapsulating data (STEP 220) are depicted in greater detail. Encapsulation process (STEP 220) may in turn include separating original data 212 into portions 214, 216 and converting those portions 214, 216 into a variety of different formats 250, 260. The resulting portions 252, 254, 262, 264 of data in different formats 250, 260 cover time periods 270, 280 corresponding to portions 214, 216 of original data 212. In other words, a portion 252 of data in one format 250 covers the same time period (quanta) 270 of original data 212 as corresponding portion 262 in another format 260.

To elucidate more clearly, if incoming original data 212 is digitized video data, original data 212 may be divided into portions 214, 216 which cover the first 20 seconds of the video represented by original data 212, with one portion 214 representing the first 10 seconds (time period one 270) and another portion 216 representing the second 10 seconds (time period two 280). Portions 214, 216 may then be converted to two different formats 250, 260. The resulting data portions 252, 262 corresponding to original portion 214 represent the same first 10 seconds (time period one 270) of original data 212, albeit in two different formats 250, 260. Similarly, data portions 254, 264 corresponding to original data portion 216 represent the second 10 seconds (time period 2 280) of original data. 212 in two different formats 250, 260.

Additionally, during this conversion process each portion 252, 254, 262, 264 of the data may be augmented. For example, information regarding closed captioning may be added to a portion of video data represented in the MPEG format, billing information may be added to a portion of a web page represented in HTML, or Java content may be added to a portion of the data to provide interactive controls to users of mobile device 180. These portions 252, 254, 262, 264 of data may also be optimized for delivery to a device 180 through the use of compression algorithms and the like.

After original data 212 is separated into portions 214, 216 and converted into different formats 250, 260, the resulting data portions 252, 254, 262, 264 may then be encapsulated in packets 256, 258, 266, 268 for delivery to device 180. Typical file formats for the encapsulation of data include layers dedicated to transmission protocols, application protocols, payload formats, and content formats. Ideally, the data format could also be used to deliver commands to the devices 180, 182, 184 which are to process, control, and render the data contained within those packets 256, 258, 266, 268.

In one embodiment, the encapsulation of the various portions of data 252, 254, 262, 264 uses a data format which allows the efficient encapsulation, transmission, reception, and decomposition of heterogeneous data. A packet 256, 258, 266, 268 may contain commands which have identical easy to decode structures, and which may be evaluated and executed in the order in which they are encoded, greatly simplifying the evaluation and execution of the commands, and rendering of the data, contained within a packet 256, 258, 266, 268.

More specifically, during encapsulation (STEP 220), each portion of data 252, 254, 262, 264 is evaluated to produce a set of commands, which when executed in a certain order are operable to instruct a decoding or rendering device to present the respective portion of data 252, 254, 262, 264. This set of commands can then be encapsulated into packets 256, 258, 266, 268 for delivery to device 180 by concatenating the set of commands. All encapsulated commands may have the same structure, and the order of command evaluation or execution may be determined by the order in which the commands are encapsulated (and possibly the side effects of the evaluation). Each command may in turn be composed of a tag or command identifier, a length indicator and a data payload.

For example, the Bakus-Naur Form (BNF) of one embodiment of this type of data format is:

encapsulation := <command>*
command := <tag><length><payload>
tag := <byte>
length := [0-9]{12} (an integer in %012d format)
payload := <bytes>{<length>}

In this embodiment, a command identifier or tag is a character with an associated or mnemonic relationship to the functionality of the command. Using the example above, the command identifier is a single byte character: tag:=<byte>. An exemplary embodiment of a set of commands and their associated command identifiers is presented in Appendix A. In other embodiments, command identifiers can also be: multiple bytes, partial bytes (fewer than 8 bits) or strings.

Continuing with the above embodiment, a payload length indicator (length) is represented as a fixed length, ASCII encoded, zero prefix number. Using the example above, the payload length is twelve digits: length:=[0-9]{12} (an integer in %012d format). For example, a number of 000000002500 would indicate a payload which is 2500 bytes.

It will be apparent to those of skill in the art that payload length could also be specified using many numbering schemas, including: fixed length ASCII representation in decimal (base 10); fixed length ASCII representation in hexadecimal (base 16); fixed length ASCII representation in some other base; variable length ASCII representation, where a fixed length number is specified which specifies the length of payload representation (for example: if the length-length is identified with 1 ASCII digit, 217 would specify a payload length of 17, and 3568 would specify a payload length of 568, as in the fixed length case, this can be done using any base); fixed length binary representation, in either little-endian or big-endian order (this is how numbers are typically stored in a computer when human readability is not required) or variable length binary representation, where the first byte (or fixed number of bytes, or bits) establishes how many of the following bytes (or bits) encode the payload length.

Returning to the above embodiment, a data payload (payload) is composed of a series of bytes whose length is indicated by the payload length indicator. Using the above example, the data payload is: payload:=<bytes>{<length>}.

An example may be useful in explaining this specific embodiment in more detail. Suppose a portion of data 252, 254, 262, 264 is represented by the following XML code:

<image src=“image0.jpg” />
<text>this is a caption 0</text>
<display />
<pause duration=1000/>
<image src=“image1.jpg” />
<display />
<pause duration=3000/>
<text>this is a caption 1</text>
<display />
<pause duration=4000/>
<image src=“image2.jpg” />
<text>this is a caption 2</text>
<display />
<pause duration=6000/>

This XML code may be encapsulated in the embodiment of the data format explained above as follows:

I000000012345[...12345 image bytes
here...]C000000000019this is a
caption0D000000000000P000000000012000000001000I0000000123
45[...12345 image bytes
here...]D000000000000P000000000012000000003000C0000000000
19this is a caption
1D000000000000P000000000012000000004000I000000012345[...1
2345 image bytes here...]C000000000019this is a caption
2D000000000000P000000000012000000001000

It will be apparent that many variations on the above data format may be utilized as well. For example, in some embodiments the order of the command identifier and payload length may be in different orders, while in other embodiments the length of the command identifier could be included in the payload length.

Referring again to FIG. 3, after the incoming data is digitized (STEP 210), converted to a variety of formats and encapsulated in packets (STEP 220), packets 232 may be selected for delivery to a device 180 based on a set of criteria 234 (STEP 230). A user of device 180 may wish to obtain certain content. That content may be digitized (STEP 210) and encapsulated into packets of varying formats (STEP 220). Packets 232 may then be selected to be delivered to device 180 based on a set of criteria (STEP 230).

This criteria 234 may include user influenced factors such as bandwidth availability, the type of device 180, time of day, user account information or subscription service, and user age and preferences. Criteria 234 may also include external factors such as the network configuration, the CPU and databases being utilized in the system, and channel availability. Criteria 234 may be updated dynamically as packets 232 are selected to be delivered to device 180. Additionally, criteria 234 may be obtained directly from device 180, either via querying device 180 directly, or device 180 updating criteria 234 dynamically at the behest of a user. An extensive list of criteria 234 which may be used in the selection of packets 232, and means of obtaining and updating these criteria 234, will be obvious to those of ordinary skill in the art.

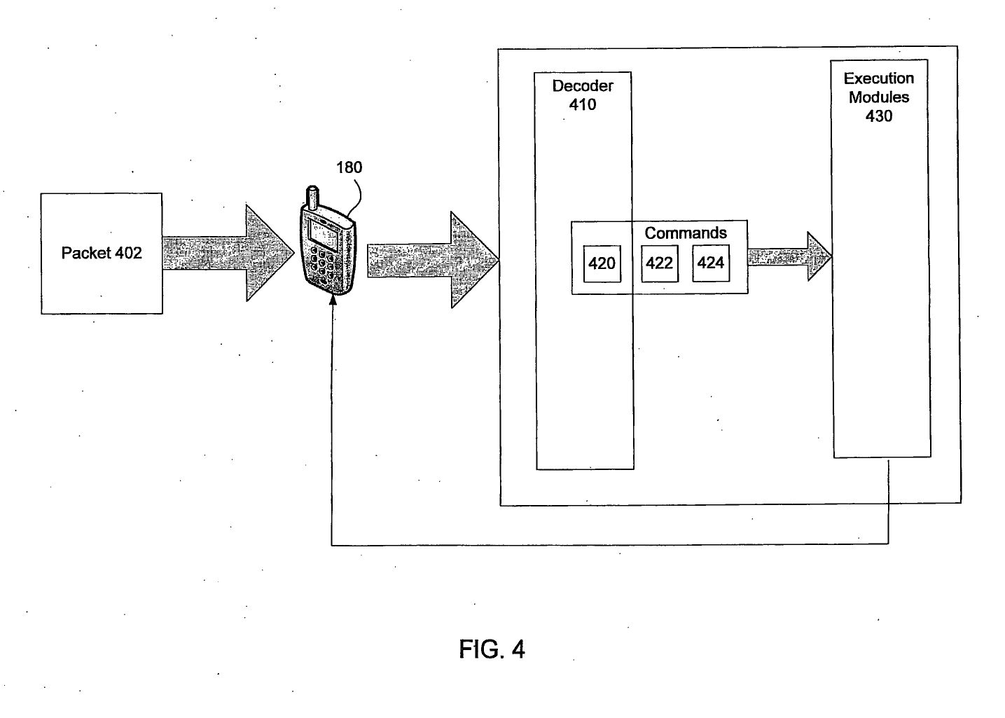

Based on criteria 234 packets 232 may be selected for delivery to device 180 (STEP 230). Turning now to FIG. 4, an embodiment of the reception and processing of packets 232 by a mobile device is depicted. Mobile device 180 may receive packet 402 from media bridge 130 via base station 110. Decoder 410, on mobile device 180, may then extract each command 420, 422, 424 encapsulated in packet 402. In one embodiment, packet 402 may be in the data format described above where each command 420, 422, 424 is composed of a single character command identifier, followed by a 12 digit (zero-prefixed) length, followed by a data payload which is of this length. Decoder 410 identifies an encapsulated command 420, 422, 424 by identifying a tag and a corresponding payload using the length element of each command 420, 422, 424.

For each command 420, 422, 424, decoder 410 may perform a corresponding action. In one embodiment, decoder may identify the type of command 420, 422, 424 using the associated tag. This command may then be passed to one of execution modules 430 based on the type of command 420, 422, 424.

In one particular embodiment, decoder 410 on mobile device 180 is implemented as a finite state machine which evaluates commands 420, 424, 426 based on the order in which commands 420, 422, 426 are encapsulated in packet 402. For each command 420, 422, 424, decoder 410 may identify the type of command 420, 422, 424 using the associated command tag. If the decoder is able to execute command 420, 422, 424 it may pass command 420, 422, 424 to one of a set of execution modules 430, where command 420, 422, 424 may be executed and the state of mobile device 180 altered accordingly. When decoder 410 encounters a command 420, 422, 424 which it does not know how to evaluate decoder 410 may skip the remaining portion of this command using the length portion of the command to determine the start of the next command. By skipping unknown commands new command types may be added to a data format while still allowing legacy devices to process the data format.

It will be apparent that because embodiments of the data format discussed allow commands within a packet to be executed in the order encountered, a command may decoded and passed to an execution module for execution. During execution of this first command a second command may be decoded. This allows a packet to be decoded and rendered more efficiently. For example, command 424 may be decoded and passed to execution modules 430 for execution. Simultaneously with the execution of command 424 decoder 430 may be in the process of decoding command 422 from packet 402.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

### Appendix A

A collection of commands, and corresponding command identifiers, used in one embodiment is given below. For each command, a decoder of the data format may perform some action. If the action taken by the decoder is correlated with intent of the encoded command, then the decoder can be instructed to present a television program (or other multimedia experience) to the end user of a device if an appropriate sequence of commands is chosen by the encoder.

The following commands are used in one embodiment:
‘A’ Audio: Use the ‘A’ command to represent an audio clip in a format supported by the end device, such as AMR, qcelp, MP3, etc.

‘C’ Caption: Use the ‘C’ command to display a line of text below the current image. In BNF,

caption := [<char_set_spec>]{<text_line>,<color_spec>}*
char_set_spec := ‘+’<2-digit-length><char_set_name>
color_spec := ‘@’,‘ ’,<3-digit-R>,<3-digit-G>,<3-digit-B>

A caption can contain an optional character set specification, which is indicated by a caption beginning with a ‘+’, followed by a two digit zero-prefixed length, and a character set name.

For example a caption beginning with:
“+08ShiftJIS”
   indicates the remainder of the caption is in ShiftJIS format. A caption contains a series of lines of text and, or color specifications. A color specification is indicated by a ‘@’ followed by a space then three 3 digit (zero-prefixed) bytes indicating the red, green and blue color components, followed by a ‘\n’. For example, caption lines following:
“@ 255 000 127\n”
   will be drawn in a light purple.

A line of text is any series of characters not beginning with ‘@’ and terminated by ‘\n’
‘D’ Display: Use the ‘D’ command to redraw the display using the current image, and caption.
No payload (length 0).
‘G’ Go to: Use the ‘G’ command to continue rendering from an indicated point within the current encapsulation. In BNF,
   goto:=<encapsulation_pointer>
‘I’ Image: Use the ‘I’ command to represent a single image in JPEG, GIF or PNG.
‘K’ Sub-encapsulation: Use the ‘K’ command to encapsulate a collection of commands into a sub-encapsulation. Especially useful in combination with the ‘*’ command reference. In BNF,
   subencapulation:=<encapsulation>

‘O’ Overlay text: Use the ‘O’ command to accept text overlay. In BNF,

```
    upgrade-now := ‘O’ <payload-length> <formatted-string>
    string := <formatted-line>*
    formatted-line := centered-line | no-break-line
        | color-settting | regular-line
    centered-line := ‘˜’ <regular-line> ‘\n’
    no-break-line-line := ‘+’ <regular-line> ‘\n’
    color-settting := ‘@’ <red-color> <green-color> <blue-
color>
    red-color := color
    greeen-color := color
    blue-color := color
    color := [0-9]{3} // 3 digit 0 prefixed number from 000-255
    regular-line := <chars>*
```

‘P’ Pause: Use the ‘P’ command to pause rendering for an absolute time-index relative to the start of the stream. Indicated by the ASCII formatted integer payload. In BNF,
   milliseconds:=<number>
   number:=[0-9]+

‘R’ RTSP: Use the ‘R’ command to begin rendering of streamed content via an RTSP url. In BNF,

```
    rtsp-command := ‘R’ <payload-length> <rtsp-url>
    rtsp-url := <chars>* // length == payload-length, points to
streamed content
    to begin rendering
```

‘S’ Store variable: Use the ‘S’ command to store the defined variable. In BNF,
   store-vars:=‘S’<no-payload-length>
   no-payload-length:=000000000000
‘U’ Do upgrade: Use the ‘U’ command to perform an application upgrade. In BNF,
   upgrade-now:=‘U’<no-payload-length>
‘V’ Vibrate: Use the ‘V’ command to turn the phone vibration on for a specified duration. In BNF,
   vibrate:=<duration>
   duration:=<number>

‘W’ Wait: Use the ‘W’ command to prompt the user for the specified number of characters indicated by the ASCII formatted integer payload and store it in the indicated variable. In BNF,

wait := <variable><number>
variable := <string>
string := <string_length><string_chars>
string_chars := {<char>,<variable_reference>}*
var_ref := ‘{‘<var_name>’}’
var_name := <char>*

All strings are evaluated for variable substitution. The string:
“the value of VAR is {VAR}”
   will substitute the current value of the variable<VAR
‘X’ Exit: Use the ‘X’ command to terminate rendering of the current encapsulation. In BNF,
   exit:=no payload
‘a’ Assign: Use the ‘a’ command to store an encapsulation for later retrieval. In BNF,
   assignment:=<variable><encapsulation>
‘b’ Playback previous: Use the ‘b’ command to playback the previously queued video clip. In BNF,
   playback-command:=‘b’<payload-length><media-type>
‘p’ Preamble: Use the ‘p’ command to encapsulate commands which are rendered by the client BEFORE the next request is made. In BNF,
   setifunset:=‘p’<payload-length><preamble-payload>
   preamble-payload:=<cef-commands>*

‘q’ Queue: Use the ‘q’ command to queue up the media clip for playback. In BNF,

```
    queue-command := ‘q’ <payload-length> <media-type> <media-
payload>
    media-type := [aiv] // a for audio, i for image, v for
video
    media-payload := <bytes>* // length == payload-length − 1
```

‘r’ Retrieve: Use the ‘r’ command to retrieve and render the stored command. In BNF,
   retrieval:=<variable>
‘s’ Store videos: Use the ‘s’ command to store the specified videos. In BNF,
   store-videos:=‘s’<no-payload-length>
‘u’ Upgrade available: Use the ‘u’ command to determine the application upgrade availability. In BNF,
   upgrade-avail:=‘u’<no-payload-length>
‘v’ Video playback: Use the ‘v’ command to playback the video clip as soon as possible.
‘=’ Set variable: Use the ‘=’ command to set the variable for later comparison or retrieval. In BNF,
   set:=<variable><value>
   value:=<string>
Use the variable MODE to change the play mode to the indicated value In BNF,
   SetMode:=[0-3]
Use the variable STATE to change the play mode to the indicated value. In BNF,
   SetState:=<chars>*
‘*’ Reference command: Use the ‘*’ command to render a single command from within the same encapsulation. This command can be used to repeat commands without duplicating data. In BNF,
   command_ref:=<encapsulation_pointer>
   encapsulation_pointer:=<number>
‘+’ Request append: Use the ‘+’ command to append a variable to the next HTTP request. For example, the string:
   ‘&’+<var_name>+‘=’+<var_value>
      is appended to the end of the next HTTP request. In BNF,
   append_var:=<variable>

‘ ’ Set if unset: Use the ‘ ’ command to set an unset variable. In BNF,

setifunset := ‘−’<payload-length><setifunset-payload>
payload-length := 12length
setifunset-payload := <variable-cstring><variable-value>
setifunset := ‘−’<variable-cstring><variable-value>
variable-cstring := cstring
cstring := <12length><chars>{12length}
12length := [0-9]{12} // 0 prefixed 12 digit number

‘?’Conditional execution: Use the ‘?’ command to compare two values or variables using the indicated test. If the test returns true, evaluate the sub-encapsulation. In BNF,

cond_ex := <test><var_val><var_val><encapsulation>
test := {‘==’,‘!=’}
var_val := string

1. A method for encapsulating data, comprising:
forming a set of commands, wherein each command comprises:
a command identifier;
a length indicator; and
a data payload; and
concatenating the set of commands.

2. The method of claim 1, wherein the set of commands is formed based on the data.

3. The method of claim 2, further comprising determining an order of execution for the set of commands.

4. The method of claim 3, wherein the commands are concatenated based on the order of execution.

5. The method of claim 4, wherein the set of commands is operable to render the data.

6. The method of claim 5, wherein the set of commands includes a command operable to decode an image, play audio, set a caption, pause up to timestamp, display data, enqueue or decode video, or playback video.

7. The method of claim 5, wherein the data may be image data, video data, audio data, text data or user interaction data.

8. The method of claim 7, wherein the data payload is a portion of the data.

9. The method of claim 5, wherein the command identifier is followed by the length, and the length is followed by the payload.

10. The method of claim 9, wherein the command identifier is a byte.

11. The method of claim 10, wherein the byte is a character with a mnemonic relationship to the command.

12. The method of claim 10, wherein the command identifier is multiple bytes, a partial byte or a string.

13. The method of claim 10, wherein the length indicator specifies the length of the command.

14. The method of claim 13, wherein the length is 12 digits.

15. The method of claim 14, wherein the length is specified using a fixed length ASCII representation in decimal, a fixed length ASCII representation in hexadecimal, variable length ASCII representation, fixed length binary representation or variable length binary representation.

16. A computer readable medium, having data embodied thereon, the data represented in a data format, wherein the data format comprises:
a set of commands, wherein each command comprises:
a command identifier;
a length indicator; and
a data payload.

17. The computer readable medium of claim 16, wherein the set of commands is based on the data.

18. The computer readable medium of claim 17, wherein the commands are in an order of execution.

19. The computer readable medium of claim 18, wherein the set of commands is operable to render the data.

20. The computer readable medium of claim 19, wherein the set of commands includes a command operable to decode an image, play audio, set a caption, pause up to timestamp, display data, enqueue or decode video, or playback video.

21. The computer readable medium of claim 19, wherein the data may be image data, video data, audio data, text data or user interaction data.

22. The computer readable medium of claim 19, wherein the data payload is a portion of the data.

23. The computer readable medium of claim 19, wherein the command identifier is followed by the length, and the length is followed by the payload.

24. The computer readable medium of claim 23, wherein the command identifier is a byte.

25. The computer readable medium of claim 24, wherein the byte is a character with a mnemonic relationship to the command.

26. The computer readable medium of claim 24, wherein the command identifier is multiple bytes, a partial byte or a string.

27. The computer readable medium of claim 24, wherein the length indicator specifies the length of the command.

28. The computer readable medium of claim 27, wherein the length is 12 digits.

29. The computer readable medium of claim 28, wherein the length is specified using a fixed length ASCII representation in decimal, a fixed length ASCII representation in hexadecimal, variable length ASCII representation, fixed length binary representation or variable length binary representation.

30. A method for encapsulating data, comprising:
forming a set of commands based on the data, wherein the set of commands is operable to render the data and each command comprises:
a command identifier;
a length indicator; and
a data payload; and
concatenating the set of commands in an order of execution.
